(19) United States
(12) Patent Application Publication
(10) Pub. No.: US 2023/0064604 A1
(43) Pub. Date: Mar. 2, 2023

(54) RUBBER COMPOSITION AND CROSSLINKED RUBBER MOLDED PRODUCT

(71) Applicant: Sumitomo Rubber Industries, Ltd., Kobe-shi (JP)

(72) Inventors: Hiroshi TADAOKA, Kobe-shi (JP); Kazuyoshi SHIGA, Kobe-shi (JP)

(73) Assignee: Sumitomo Rubber Industries, Ltd., Kobe-shi (JP)

(21) Appl. No.: 17/894,430

(22) Filed: Aug. 24, 2022

(30) Foreign Application Priority Data
Aug. 25, 2021 (JP) 2021-137272
Nov. 4, 2021 (JP) 2021-180404

(51) Int. Cl. C08K 5/47; C08K 5/098

(52) U.S. Cl. CPC C08K 5/47; C08K 5/098; A63B 37/0051

(57) ABSTRACT

An object of the present disclosure is to provide a rubber composition from which a molded product crosslinked in a short time and having high hardness can be obtained. The present disclosure provides a rubber composition containing (a) a base rubber, (b) a co-crosslinking agent, (c) a crosslinking initiator, and (d) a benzothiazole compound, wherein (d) the benzothiazole compound is a specific benzothiazole compound, and a relationship of {(T2-T1)/(X-18)} ≥ 0.46 is satisfied, wherein X is an amount (parts by mass) of (b) the co-crosslinking agent with respect to 100 parts by mass of (a) the base rubber, T1 is a torque (N^{.}m) at 35 seconds and T2 is a torque (N^{.}m) at 45 seconds from a start of measuring the torque of the rubber composition when conducting a crosslinking test of the rubber composition at a temperature of 170° C.

### FIELD OF THE INVENTION

The present disclosure relates to a rubber composition, and particularly relates to a rubber composition crosslinking in a short time.

### DESCRIPTION OF THE RELATED ART

It light of good resilience, a rubber composition containing a base rubber, a co-crosslinking agent and a crosslinking initiator is widely used as a material for forming a core of a golf ball.

For example, JP 2005-000647 A discloses a golf ball comprising a composition containing an unsaturated polymer, a crosslinking agent, a peptizer which is a nonmetal salt of an organic sulfur compound, and an accelerator selected from the group consisting of 2-mercaptobenzothiazole and a salt of 2-mercaptobenzothiazole (refer to claims 1, 7 and 11 of JP 2005-000647 A).

In addition, JP 2005-000657 A discloses a golf ball comprising a composition containing an unsaturated polymer, a crosslinking agent, a peptizer, and a vulcanization accelerator, wherein the vulcanization accelerator is selected from the group consisting of 2-mercaptobenzothiazole and a salt of 2-mercaptobenzothiazole (refer to claims 1 and 25 of JP 2005-000657 A).

### SUMMARY OF THE INVENTION

Although various rubber compositions have been proposed, there is a problem that the conventional rubber compositions require a long time for crosslinking. In addition, the crosslinking cannot be effectively formed in the conventional rubber compositions, thus a large amount of the co-crosslinking agent is necessary to increase the hardness of the cured product. The present disclosure has been achieved in view of the above circumstances, and an object of the present disclosure is to provide a rubber composition crosslinking in a short time and providing a molded product having a high hardness.

The first embodiment according to the present disclosure that has solved the above problems provides a rubber composition containing (a) a base rubber, (b) a co-crosslinking agent, (c) a crosslinking initiator, and (d) a benzothiazole compound, wherein (d) the benzothiazole compound is at least one member selected from the group consisting of a compound represented by the formula (1), a compound represented by the formula (2), and a compound represented by the formula (3), and a relationship of {(T2-T1)/(X-18)} ≥ 0.46 is satisfied, wherein X is an amount (parts by mass) of (b) the co-crosslinking agent with respect to 100 parts by mass of (a) the base rubber, T1 is a torque (N·m) at 35 seconds and T2 is a torque (N·m) at 45 seconds from a start of measuring the torque of the rubber composition when conducting a crosslinking test of the rubber composition at a temperature of 170° C.

The second embodiment according to the present disclosure that has solved the above problems provides a rubber composition containing (a) a base rubber, (b) a co-crosslinking agent, (c) a crosslinking initiator, (d) a benzothiazole compound, and (f) an organic sulfur compound, wherein (d) the benzothiazole compound is at least one member selected from the group consisting of a compound represented by the formula (1), a compound represented by the formula (2), and a compound represented by the formula (3), and a relationship of {(T4-T3)/(X-18)} > 0.3 is satisfied, wherein X is an amount (parts by mass) of (b) the co-crosslinking agent with respect to 100 parts by mass of (a) the base rubber, T3 is a torque (N·m) at 10 seconds and T4 is a torque (N·m) at 60 seconds from a start of measuring the torque of the rubber composition when conducting a crosslinking test of the rubber composition at a temperature of 170° C.

If the rubber composition according to the present disclosure is used, a molded product having high hardness can be obtained in a short crosslinking time.

### BRIEF DESCRIPTION OF THE DRAWINGS

FIG. 1 shows a relationship between the crosslinking time and the torque of the rubber composition;

FIG. 2 shows a relationship between the crosslinking time and the torque of the rubber composition;

FIG. 3 shows a relationship between the crosslinking time and the torque of the rubber composition;

FIG. 4 shows a relationship between the crosslinking time and the torque of the rubber composition; and

FIG. 5 shows a relationship between the crosslinking time and the torque of the rubber composition.

### DESCRIPTION OF THE PREFERRED EMBODIMENT

### Rubber Composition

The present disclosure provides a rubber composition containing (a) a base rubber, (b) a co-crosslinking agent, (c) a crosslinking initiator, and (d) a specific benzothiazole compound. The rubber composition according to the present disclosure contains (d) the specific benzothiazole compound, thus the rubber composition crosslinks in a short time.

Next, the materials used for the rubber composition will be explained.

### (a) Base Rubber

As (a) the base rubber, a natural rubber and/or a synthetic rubber can be used. Examples of the synthetic rubber include a diene rubber such as polybutadiene rubber (BR), polyisoprene rubber (IR), styrene-polybutadiene rubber (SBR), chloroprene rubber (CR), butyl rubber (IIR), and acrylonitrile-butadiene rubber (NBR); and a nondiene rubber such as ethylene-propylene rubber (EPM), ethylene-propylene-diene rubber (EPDM), urethane rubber, silicone rubber, acrylic rubber, epichlorohydrin rubber, polysulfide rubber, fluorinated rubber, and chlorosulfonated polyethylene rubber. The rubber may be used solely, or two or more of them may be used in combination.

(a) The base rubber preferably contains the natural rubber and/or the diene rubber. The total amount of the natural rubber and/or the diene rubber in (a) the base rubber is preferably 50 mass % or more, more preferably 70 mass % or more, and even more preferably 90 mass % or more. It is also preferable that (a) the base rubber consists of the natural rubber and/or the diene rubber.

(a) The base rubber preferably includes a polybutadiene rubber, and particularly preferably includes a high-cis polybutadiene having a cis-1,4 bond in an amount of 40 mass % or more, preferably 80 mass % or more, and more preferably 90 mass % or more in view of its superior resilience. The amount of the high-cis polybutadiene in (a) the base rubber is preferably 50 mass% or more, more preferably 70 mass% or more.

The amount of the 1 ,2-vinyl bond in the high-cis polybutadiene is preferably 2.0 mass % or less, more preferably 1.7 mass % or less, and even more preferably 1.5 mass % or less. If the amount of the 1 ,2-vinyl bond is excessively great, the resilience may be lowered.

The high-cis polybutadiene is preferably a polybutadiene synthesized using a rare earth element catalyst. When a neodymium catalyst, which employs a neodymium compound that is a lanthanum series rare earth element compound, is used, a polybutadiene rubber having a high content of a cis-1,4 bond and a low content of a 1,2-vinyl bond is obtained with excellent polymerization activity. Such a polybutadiene rubber is particularly preferred.

The high-cis polybutadiene preferably has a molecular weight distribution Mw/Mn (Mw: weight average molecular weight, Mn: number average molecular weight) of 2.0 or more, more preferably 2.2 or more, even more preferably 2.4 or more, and most preferably 2.6 or more, and preferably has a molecular weight distribution Mw/Mn of 6.0 or less, more preferably 5.0 or less, even more preferably 4.0 or less, and most preferably 3.4 or less. If the molecular weight distribution (Mw/Mn) of the high-cis polybutadiene is excessively low, the processability deteriorates. If the molecular weight distribution (Mw/Mn) of the high-cis polybutadiene is excessively high, the resilience may be lowered. It is noted that the measurement of the molecular weight distribution is conducted by gel permeation chromatography (“HLC-8120GPC”, available from Tosoh Corporation) using a differential refractometer as a detector under the conditions of column: GMHHXL (available from Tosoh Corporation), column temperature: 40° C., and mobile phase: tetrahydrofuran, and calculated by converting based on polystyrene standard.

The Mooney viscosity (ML₁₊₄ (100° C.)) of the high-cis polybutadiene is preferably 30 or more, more preferably 32 or more, and even more preferably 35 or more, and is preferably 140 or less, more preferably 120 or less, even more preferably 100 or less, and most preferably 80 or less. It is noted that the Mooney viscosity (ML₁₊₄ (100° C.)) in the present disclosure is a value measured according to JIS K6300 using an L rotor under the conditions of: a preheating time of 1 minute; a rotor revolution time of 4 minutes; and a temperature of 100° C.

### (b) Co-Crosslinking Agent

(b) The co-crosslinking agent has an action of crosslinking a rubber molecule by graft polymerization to a base rubber molecular chain. (b) The co-crosslinking agent preferably includes an α,β-unsaturated carboxylic acid having 3 to 8 carbon atoms and/or a metal salt thereof, more preferably the metal salt of the α,βunsaturated carboxylic acid having 3 to 8 carbon atoms. The α,β-unsaturated carboxylic acid used as (b) the co-crosslinking agent preferably has 3 to 8 carbon atoms, more preferably has 3 to 6 carbon atoms, and even more preferably has 3 or 4 carbon atoms. It is noted that the α,β-unsaturated carboxylic acid having 3 to 8 carbon atoms and/or the metal salt thereof may be used solely, or two or more of them may be used in combination.

Examples of the α,β-unsaturated carboxylic acid having 3 to 8 carbon atoms include acrylic acid, methacrylic acid, fumaric acid, maleic acid and crotonic acid. When the rubber composition contains only the α,β-unsaturated carboxylic acid having 3 to 8 carbon atoms as the co-crosslinking agent, the rubber composition preferably further contains (e) a metal compound. Neutralizing the α,β-unsaturated carboxylic acid having 3 to 8 carbon atoms with the metal compound in the rubber composition provides substantially the same effect as using the metal salt of the α,β-unsaturated carboxylic acid having 3 to 8 carbon atoms as the co-crosslinking agent.

Examples of the metal ion constituting the metal salt of the α,β-unsaturated carboxylic acid having 3 to 8 carbon atoms include a monovalent metal ion such as sodium, potassium and lithium; a divalent metal ion such as magnesium, calcium, zinc, barium and cadmium; a trivalent metal ion such as aluminum; and other metal ion such as tin and zirconium. The above metal component may be used solely or as a mixture of at least two of them. Among them, the divalent metal ion such as magnesium, calcium, zinc, barium and cadmium is preferably used as the metal component. This is because if the divalent metal salt of the α,β-unsaturated carboxylic acid having 3 to 8 carbon atoms is used, a metal crosslinking easily generates between the rubber molecules. Especially, the divalent metal salt is preferably the zinc salt of the α,β-unsaturated carboxylic acid having 3 to 8 carbon atoms, more preferably zinc acrylate, because use of such divalent metal salt enhances the resilience of the obtained golf ball. It is noted that when the α,βunsaturated carboxylic acid having 3 to 8 carbon atoms is used together with the metal salt thereof as the co-crosslinking agent, (e) the metal compound may be used as an optional component.

When the metal is a divalent or trivalent metal, the metal salt of (b) the α,βunsaturated carboxylic acid having 3 to 8 carbon atoms may further include another carboxylic acid than the α,β-unsaturated carboxylic acid having 3 to 8 carbon atoms, as the carboxylic acid moiety. Examples of the other carboxylic acids include a saturated carboxylic acid such as caprylic acid, capric acid, lauric acid, myristic acid, palmitic acid, stearic acid, arachidic acid, and behenic acid; and an unsaturated carboxylic acid such as palmitoleic acid, oleic acid, linoleic acid, linolenic acid, and arachidonic acid.

The amount of (b) the co-crosslinking agent is preferably more than 18 parts by mass, more preferably 20 parts by mass or more, even more preferably 25 parts by mass or more, and most preferably 27 parts by mass or more, and is preferably 50 parts by mass or less, more preferably 45 parts by mass or less, and even more preferably 35 parts by mass or less, with respect to 100 parts by mass of (a) the base rubber. If the amount of (b) the co-crosslinking agent is more than 18 parts by mass, the member formed from the rubber composition has an appropriate hardness with a small amount of (c) the crosslinking initiator. On the other hand, if the amount of (b) the co-crosslinking agent is 50 parts by mass or less, the member formed from the rubber composition is not excessively hard.

### (c) Crosslinking Initiator

(c) The crosslinking initiator is blended to crosslink (a) the base rubber component. As (c) the crosslinking initiator, an organic peroxide is suitable. Specific examples of the organic peroxide include dicumyl peroxide, 1,1-bis(t-butylperoxy)-3,3,5-trimethylcyclohexane, 2,5-dimethyl-2,5-di(t-butylperoxy) hexane and di-t-butyl peroxide. These organic peroxides may be used solely or as a mixture of at least two of them. Among them, dicumyl peroxide is preferably used.

The one minute half-life temperature of (c) the crosslinking initiator is preferably 120° C. or more, more preferably 140° C. or more, and even more preferably 150° C. or more, and is preferably 200° C. or less, more preferably 190° C. or less, and even more preferably 180° C. or less.

The amount of (c) the crosslinking initiator is preferably 0.2 part by mass or more, more preferably 0.5 part by mass or more, and even more preferably 0.7 part by mass or more, and is preferably 5.0 parts by mass or less, more preferably 2.5 parts by mass or less, even more preferably 2.0 parts by mass or less, and most preferably 0.9 part by mass or less, with respect to 100 parts by mass of (a) the base rubber. If the amount of (c) the crosslinking initiator is 0.2 part by mass or more, the crosslinked rubber molded product formed from the rubber composition is not excessively soft, and thus the resilience is better, and if the amount of (c) the crosslinking initiator is 5.0 parts by mass or less, the crosslinked rubber molded product formed from the rubber composition has an appropriate hardness, and thus the resilience and the durability are better.

### (d) Benzothiazole Compound

(d) The benzothiazole compound used in the present disclosure will be explained. Examples of (d) the benzothiazole compound includes a compound represented by the formula (1), a compound represented by the formula (2), and a compound represented by the formula (3). If (d) the benzothiazole compound is added, the crosslinking can be effectively formed, and the time required for crosslinking the rubber composition can be shortened. In addition, since the crosslinking can be effectively formed, a molded product having high hardness can be obtained even if a small amount of (b) the co-crosslinking agent is used.

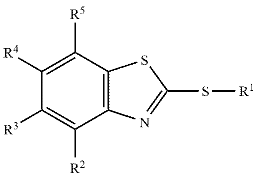

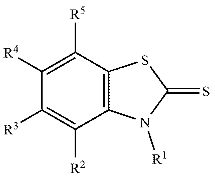

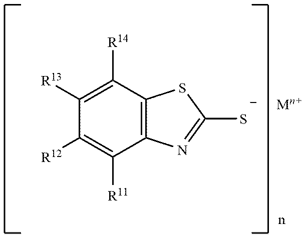

[R¹ represents a hydrogen atom, an alkyl group having 1 to 8 carbon atoms, an aryl group having 4 to 14 carbon atoms, or a metal atom.

R² to R⁵ are identical to or different from each other and represent a hydrogen atom, a halogen atom, an alkyl group having 1 to 8 carbon atoms, an aryl group having 4 to 14 carbon atoms, an alkoxy group having 1 to 8 carbon atoms, or a perfluoroalkyl group having 1 to 8 carbon atoms.]

[R¹¹ to R¹⁴ are identical to or different from each other and represent a hydrogen atom, a halogen atom, an alkyl group having 1 to 8 carbon atoms, an aryl group having 4 to 14 carbon atoms, an alkoxy group having 1 to 8 carbon atoms, or a perfluoroalkyl group having 1 to 8 carbon atoms. M represents a metal atom. n represents 1 or 2.]

The compound represented by the formula (3) is more preferably a compound represented by the formula (31).

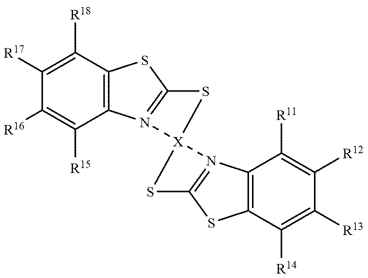

[R¹¹ to R¹⁸ are identical to or different from each other and represent a hydrogen atom, a halogen atom, an alkyl group having 1 to 8 carbon atoms, an aryl group having 4 to 14 carbon atoms, an alkoxy group having 1 to 8 carbon atoms, or a perfluoroalkyl group having 1 to 8 carbon atoms.

X represents a divalent metal atom.]

Examples of the alkyl group having 1 to 8 carbon atoms represented by R¹ in the formula (1) or the formula (2) include a linear alkyl group, a branched alkyl group, and a cyclic alkyl group. The alkyl group preferably has 1 or more carbon atoms, and preferably has 6 or less carbon atoms, more preferably has 4 or less carbon atoms.

Examples of the linear alkyl group include a methyl group, an ethyl group, a n-propyl group, a n-butyl group, and a n-pentyl group.

Examples of the branched alkyl group include an isopropyl group, an isobutyl group, a s-butyl group, a t-butyl group, and an isopentyl group.

Examples of the cyclic alkyl group include a cyclopropyl group, a cyclobutyl group, a cyclopentyl group, and a cyclohexyl group.

The aryl group having 4 to 14 carbon atoms represented by R¹ preferably has 12 or less carbon atoms, more preferably has 10 or less carbon atoms. Examples of the aryl group include a phenyl group and a naphthyl group.

Examples of the metal atom represented by R¹ include sodium, potassium, lithium, magnesium, calcium, zinc, barium, and cadmium.

R¹ is preferably the hydrogen atom or the alkyl group having 1 to 8 carbon atoms, and more preferably the hydrogen atom.

Examples of the halogen group represented by R² to R⁵ and R¹¹ to R¹⁸ in the formulae (1), (2), (3) or (31) include fluoro group (-F), chloro group (-CI), and bromo group (-Br).

Examples of the alkyl group having 1 to 8 carbon atoms represented by R² to R⁵ and R¹¹ to R¹⁸ include a linear alkyl group, a branched alkyl group, and a cyclic alkyl group. The alkyl group preferably has 1 or more carbon atoms, and preferably has 6 or less carbon atoms, more preferably has 4 or less carbon atoms.

Examples of the linear alkyl group include a methyl group, an ethyl group, a n-propyl group, a n-butyl group, and a n-pentyl group.

Examples of the branched alkyl group include an isopropyl group, an isobutyl group, a s-butyl group, a t-butyl group, and an isopentyl group.

Examples of the cyclic alkyl group include a cyclopropyl group, a cyclobutyl group, a cyclopentyl group, and a cyclohexyl group.

The aryl group having 4 to 14 carbon atoms represented by R² to R⁵ and R¹¹ to R¹⁸ preferably has 12 or less carbon atoms, more preferably has 10 or less carbon atoms. Examples of the aryl group include a phenyl group and a naphthyl group.

The alkoxy group having 1 to 8 carbon atoms represented by R² to R⁵ and R¹¹ to R¹⁸ preferably has 6 or less carbon atoms, more preferably has 4 or less carbon atoms. Examples of the alkoxy group include a methoxy group, an ethoxy group, a propoxy group, and a butoxy group.

The perfluoroalkyl group having 1 to 8 carbon atoms represented by R² to R⁵ and R¹¹ to R¹⁸ preferably has 6 or less carbon atoms, more preferably has 4 or less carbon atoms. Examples of the perfluoroalkyl group include a trifluoromethyl group (-CF₃), a pentafluoroethyl group (-C₂F₅), and a heptafluoropropyl group (-C₃F₇).

R² to R⁵ and R¹¹ to R¹⁸ are preferably the hydrogen atom, or the alkyl group having 1 to 8 carbon atoms, more preferably the hydrogen atom.

Examples of the monovalent metal atom represented by M in the formula (3) include sodium, potassium, and lithium, and examples of the divalent metal atom represented by M in the formula (3) include magnesium, calcium, zinc, barium, and cadmium.

Examples of the divalent metal atom represented by X in the formula (31) include magnesium, calcium, zinc, barium, and cadmium.

The amount of (d) the benzothiazole compound is preferably 0.01 part by mass or more, more preferably 0.1 part by mass or more, and even more preferably 0.5 part by mass or more, and is preferably 20 parts by mass or less, more preferably 10 parts by mass or less, and even more preferably 5 parts by mass or less, with respect to 100 parts by mass of (a) the base rubber. If the amount of (d) the benzothiazole compound is 0.01 part by mass or more, the obtained crosslinked rubber has further enhanced hardness, and if the amount of (d) the benzothiazole compound is 20 parts by mass or less, the obtained crosslinked rubber has better properties.

### (e) Metal Compound

The rubber composition may further contain (e) a metal compound. (e) The metal compound is preferably a metal compound capable of neutralizing (b) the α,βunsaturated carboxylic acid having 3 to 8 carbon atoms in the rubber composition. Examples of (e) the metal compound include a metal hydroxide such as magnesium hydroxide, zinc hydroxide, calcium hydroxide, sodium hydroxide, lithium hydroxide, potassium hydroxide, and copper hydroxide; a metal oxide such as magnesium oxide, calcium oxide, zinc oxide, and copper oxide; and a metal carbonate such as magnesium carbonate, zinc carbonate, calcium carbonate, sodium carbonate, lithium carbonate, and potassium carbonate. As (e) the metal compound, the divalent metal compound is preferable, the zinc compound is more preferable. This is because the divalent metal compound reacts with the α,β-unsaturated carboxylic acid having 3 to 8 carbon atoms to form a metal crosslinking. In addition, if the zinc compound is used, the obtained crosslinked rubber molded product has higher resilience. (e) The metal compound may be used solely, or at least two of them may be used in combination. The amount of (e) the metal compound can be appropriately adjusted.

### (f) Organic Sulfur Compound

The rubber composition may further contain (f) an organic sulfur compound. (f) The organic sulfur compound excludes (d) the benzothiazole compound. Examples of (f) the organic sulfur compound include at least one member selected from the group consisting of thiophenols, thionaphthols, polysulfides, thiurams, thiocarboxylic acids, dithiocarboxylic acids, sulfenamides, dithiocarbamates, thiazoles, and metal salts thereof. As (f) the organic sulfur compound, the organic sulfur compound having a thiol group (-SH), or the metal salt thereof is preferable, thiophenols, thionaphthols, or the metal salt thereof are more preferable.

Examples of the thiols include thiophenols and thionaphthols. Examples of the thiophenols include thiophenol; thiophenols substituted with a fluoro group, such as 4-fluorothiophenol, 2,5-difluorothiophenol, 2,6-difluorothiophenol, 2,4,5-trifluorothiophenol, 2,4,5,6-tetrafluorothiophenol and pentafluorothiophenol; thiophenols substituted with a chloro group, such as 2-chlorothiophenol, 4-chlorothiophenol, 2,4-dichlorothiophenol, 2,5-dichlorothiophenol, 2,6-dichlorothiophenol, 2,4,5-trichlorothiophenol, 2,4,5,6-tetrachlorothiophenol and pentachlorothiophenol; thiophenols substituted with a bromo group, such as 4-bromothiophenol, 2,5-dibromothiophenol, 2,6-dibromothiophenol, 2,4,5-tribromothiophenol, 2,4,5,6-tetrabromothiophenol and pentabromothiophenol; thiophenols substituted with an iodo group, such as 4-iodothiophenol, 2,5-diiodothiophenol, 2,6-diiodothiophenol, 2,4,5-triiodothiophenol, 2,4,5,6-tetraiodothiophenol and pentaiodothiophenol; and metal salts thereof. As the metal salt, zinc salt is preferable.

Examples of the thionaphthols (naphthalenethiols) include 2-thionaphthol, 1-thionaphthol, 1-chloro-2-thionaphthol, 2-chloro-1-thionaphthol, 1-bromo-2-thionaphthol, 2-bromo-1-thionaphthol, 1-fluoro-2-thionaphthol, 2-fluoro-1-thionaphthol, 1-cyano-2-thionaphthol, 2-cyano-1-thionaphthol, 1-acetyl-2-thionaphthol, 2-acetyl-1-thionaphthol, and metal salts thereof. Among them, 2-thionaphthol, 1-thionaphthol, and metal salts thereof are preferable. As the metal salt, a divalent metal salt is preferable, zinc salt is more preferable. Specific examples of the metal salt include zinc salt of 1-thionaphthol and zinc salt of 2-thionaphthol.

The polysulfides are organic sulfur compounds having a polysulfide bond, and examples thereof include disulfides, trisulfides, and tetrasulfides. As the polysulfides, diphenyl polysulfides are preferable.

Examples of the diphenyl polysulfides include diphenyl disulfide; diphenyl disulfides substituted with a halogen group, such as bis(4-fluorophenyl) disulfide, bis(2,5-difluorophenyl) disulfide, bis(2,6-difluorophenyl) disulfide, bis(2,4,5-trifluorophenyl) disulfide, bis(2,4,5,6-tetrafluorophenyl) disulfide, bis(pentafluorophenyl) disulfide, bis(4-chlorophenyl) disulfide, bis(2,5-dichlorophenyl) disulfide, bis(2,6-dichlorophenyl) disulfide, bis(2,4,5-trichlorophenyl) disulfide, bis(2,4,5,6-tetrachlorophenyl) disulfide, bis(pentachlorophenyl) disulfide, bis(4-bromophenyl) disulfide, bis(2,5-dibromophenyl) disulfide, bis(2,6-dibromophenyl) disulfide, bis(2,4,5-tribromophenyl) disulfide, bis(2,4,5,6-tetrabromophenyl) disulfide, bis(pentabromophenyl) disulfide, bis(4-iodophenyl) disulfide, bis(2,5-diiodophenyl) disulfide, bis(2,6-diiodophenyl) disulfide, bis(2,4,5-triiodophenyl) disulfide, bis(2,4,5,6-tetraiodophenyl) disulfide and bis(pentaiodophenyl) disulfide; and diphenyl disulfides substituted with an alkyl group, such as bis(4-methylphenyl) disulfide, bis(2,4,5-trimethylphenyl) disulfide, bis(pentamethylphenyl) disulfide, bis(4-t-butylphenyl) disulfide, bis(2,4,5-tri-t-butylphenyl) disulfide, and bis(penta-t-butylphenyl) disulfide.

Examples of the thiurams include thiuram monosulfides such as tetramethylthiuram monosulfide; thiuram disulfides such as tetramethylthiuram disulfide, tetraethylthiuram disulfide and tetrabutylthiuram disulfide; and thiuram tetrasulfides such as dipentamethylenethiuram tetrasulfide. Examples of the thiocarboxylic acids include naphthalene thiocarboxylic acid. Examples of the dithiocarboxylic acids include naphthalene dithiocarboxylic acid. Examples of the sulfenamides include N-cyclohexyl-2-benzothiazole sulfenamide, N-oxydiethylene-2-benzothiazole sulfenamide, and N-t-butyl-2-benzothiazole sulfenamide.

(f) The organic sulfur compound may be used solely or as a mixture of at least two of them. As (f) the organic sulfur compound, the thiophenols and/or the metal salts thereof, the thionaphthols and/or the metal salts thereof, the diphenyl disulfides, and the thiuram disulfides are preferable, 2,4-dichlorothiophenol, 2,6-difluorothiophenol, 2,6-dichlorothiophenol, 2,6-dibromothiophenol, 2,6-diiodothiophenol, 2,4,5-trichlorothiophenol, pentachlorothiophenol, 1-thionaphthol, 2-thionaphthol, diphenyl disulfide, bis(2,6-difluorophenyl) disulfide, bis(2,6-dichlorophenyl) disulfide, bis(2,6-dibromophenyl) disulfide, bis(2,6-diiodophenyl) disulfide, bis(pentabromophenyl) disulfide, and metal salts thereof are more preferable.

If the rubber composition contains (f) the organic sulfur compound other than (d) the benzothiazole compound, crosslinking-forming speed tends to be slow. Thus, in case of increasing the crosslinking speed, the amount of (f) the organic sulfur compound is preferably 5.0 parts by mass or less, more preferably 1.0 part by mass or less, even more preferably 0.05 part by mass or less, and most preferably 0.01 part by mass or less, with respect to 100 parts by mass of (a) the base rubber. The rubber composition also preferably does not contain (f) the organic sulfur compound other than (d) the benzothiazole compound.

If the rubber composition contains (f) the organic sulfur compound other than (d) the benzothiazole compound, it tends to have a slow crosslinking-forming speed although the obtained cured product has enhanced resilience performance. Thus, using (d) the benzothiazole compound in combination with (f) the organic sulfur compound can enhance the resilience performance of the cured product while suppressing the lowering in the crosslinking speed. Thus, in case of desiring to enhance the resilience performance, the amount of (f) the organic sulfur compound is preferably 0.05 part by mass or more, more preferably 0.1 part by mass or more, and is preferably 5.0 parts by mass or less, more preferably 2.0 parts by mass or less, with respect to 100 parts by mass of (a) the base rubber. If the amount of (f) the organic sulfur compound is less than 0.05 part by mass, the effect of adding (f) the organic sulfur compound may not be obtained, and thus the resilience of the crosslinked rubber molded product may not be enhanced. In addition, if the amount of (f) the organic sulfur compound is more than 5.0 parts by mass, the obtained crosslinked rubber molded product has a great compression deformation amount and thus the resilience thereof may be lowered.

### (g) Carboxylic Acid and/or Salt Thereof

The rubber composition may further contain (g) a carboxylic acid and/or a salt thereof. If the rubber composition contains (g) the carboxylic acid and/or the salt thereof, the hardness distribution of the obtained crosslinked rubber molded product can be controlled. Examples of (g) the carboxylic acid and/or the salt thereof include an aliphatic carboxylic acid, an aliphatic carboxylic acid salt, an aromatic carboxylic acid and an aromatic carboxylic acid salt. (g) The carboxylic acid and/or the salt thereof may be used solely, or as a mixture of two or more of them. It is noted that (g) the carboxylic acid and/or the salt thereof excludes the α,β-unsaturated carboxylic acid having 3 to 8 carbon atoms and the metal salt thereof used as (b) the co-crosslinking agent.

The aliphatic carboxylic acid may be either a saturated aliphatic carboxylic acid (hereinafter sometimes referred to as “saturated fatty acid”) or an unsaturated aliphatic carboxylic acid (hereinafter sometimes referred to as “unsaturated fatty acid”). In addition, the aliphatic carboxylic acid may have a branched or cyclic structure. The saturated fatty acid preferably has 6 or more carbon atoms, and preferably has 24 or less carbon atoms, more preferably has 18 or less carbon atoms, and even more preferably has 13 or less carbon atoms. The unsaturated fatty acid preferably has 6 or more carbon atoms, more preferably has 7 or more carbon atoms, and even more preferably has 8 or more carbon atoms, and preferably has 24 or less carbon atoms, more preferably has 18 or less carbon atoms, and even more preferably has 13 or less carbon atoms.

Examples of the aromatic carboxylic acid include a carboxylic acid having a benzene ring in the molecule, and a carboxylic acid having an aromatic heterocycle in the molecule. The aromatic carboxylic acid may be used solely, or two or more of them may be used in combination. Examples of the carboxylic acid having the benzene ring include an aromatic carboxylic acid having a carboxyl group directly bonding to a benzene ring, an aromatic-aliphatic carboxylic acid having an aliphatic carboxylic acid bonding to a benzene ring, a polynuclear aromatic carboxylic acid having a carboxyl group directly bonding to a fused benzene ring, and a polynuclear aromatic-aliphatic carboxylic acid having an aliphatic carboxylic acid bonding to a fused benzene ring. Examples of the carboxylic acid having the aromatic heterocycle include a carboxylic acid having a carboxyl group directly bonding to an aromatic heterocycle.

As the aliphatic carboxylic acid salt or aromatic carboxylic acid salt, a salt of the above mentioned aliphatic carboxylic acid or aromatic carboxylic acid can be used. Examples of the cation component of these salts include a metal ion, an ammonium ion, and an organic cation. The cation component may be used solely, or two or more of them may be used in combination. Examples of the metal ion include a monovalent metal ion such as sodium, potassium, lithium and silver; a divalent metal ion such as magnesium, calcium, zinc, barium, cadmium, copper, cobalt, nickel and manganese; a trivalent metal ion such as aluminum and iron; other ion such as tin, zirconium and titanium. Among them, the metal ion is preferably the divalent metal ion, more preferably magnesium, zinc, or calcium.

The organic cation is a cation having a carbon chain. The organic cation is not particularly limited, and examples thereof include an organic ammonium ion. Examples of the organic ammonium ion include a primary ammonium ion such as stearyl ammonium ion, hexyl ammonium ion, octyl ammonium ion and 2-ethylhexyl ammonium ion; a secondary ammonium ion such as dodecyl(lauryl) ammonium ion and octadecyl(stearyl) ammonium ion; a tertiary ammonium ion such as trioctyl ammonium ion; and a quaternary ammonium ion such as dioctyldimethyl ammonium ion and distearyldimethyl ammonium ion. These organic cations may be used solely, or two or more of them may be used in combination.

Examples of the aliphatic carboxylic acid and/or the salt thereof include a saturated fatty acid and/or a salt thereof, and an unsaturated fatty acid and/or a salt thereof. The saturated fatty acid and/or the salt thereof is preferable, and caprylic acid (octanoic acid), pelargonic acid (nonanoic acid), capric acid (decanoic acid), lauric acid, myristic acid, palmitic acid, stearic acid, behenic acid, and their potassium salt, magnesium salt, calcium salt, aluminum salt, zinc salt, iron salt, copper salt, nickel salt and cobalt salt, are preferable. As the unsaturated fatty acid and/or the salt thereof, palmitoleic acid, oleic acid, linoleic acid, arachidonic acid, and their potassium salt, magnesium salt, calcium salt, aluminum salt, zinc salt, iron salt, copper salt, nickel salt and cobalt salt, are preferable.

As the aromatic carboxylic acid and/or the salt thereof, benzoic acid, butylbenzoic acid, anisic acid (methoxybenzoic acid), dimethoxybenzoic acid, trimethoxybenzoic acid, dimethylaminobenzoic acid, chlorobenzoic acid, dichlorobenzoic acid, trichlorobenzoic acid, acetoxybenzoic acid, biphenylcarboxylic acid, naphthalenecarboxylic acid, anthracenecarboxylic acid, furancarboxylic acid, thenoic acid, and their potassium salt, magnesium salt, calcium salt, aluminum salt, zinc salt, iron salt, copper salt, nickel salt and cobalt salt, are particularly preferable.

For example, the amount of (g) the carboxylic acid and/or the salt thereof is preferably 1 part by mass or more, more preferably 2 parts by mass or more, and even more preferably 3 parts by mass or more, and is preferably 30 parts by mass or less, more preferably 20 parts by mass or less, and even more preferably 15 parts by mass or less, with respect to 100 parts by mass of (a) the base rubber.

### Other Components

The rubber composition may contain additives such as a pigment, a filler for adjusting weight or the like, an antioxidant, a peptizing agent, and a softener, where necessary. In addition, the rubber composition may contain a rubber powder obtained by pulverizing a golf ball core or offcuts produced when preparing a core.

Examples of the pigment blended in the rubber composition include a white pigment, a blue pigment, and a purple pigment. As the white pigment, titanium oxide is preferably used. The type of titanium oxide is not particularly limited, but rutile type is preferably used because of its high opacity. In addition, the amount of titanium oxide is preferably 0.5 part by mass or more, more preferably 2 parts by mass or more, and is preferably 8 parts by mass or less, more preferably 5 parts by mass or less, with respect to 100 parts by mass of (a) the base rubber.

It is also preferred that the rubber composition contains both the white pigment and the blue pigment. The blue pigment is blended in order to cause white color to be vivid, and examples thereof include ultramarine blue, cobalt blue, and phthalocyanine blue. In addition, examples of the purple pigment include anthraquinone violet, dioxazine violet, and methyl violet.

The filler blended in the rubber composition is used as a weight adjusting agent for adjusting the mass of the obtained crosslinked rubber molded product. The filler may be blended where necessary. Examples of the filler include an inorganic filler such as zinc oxide, barium sulfate, calcium carbonate, magnesium oxide, tungsten powder, and molybdenum powder.

The amount of the antioxidant is preferably 0.1 part by mass or more and 1 part by mass or less with respect to 100 parts by mass of (a) the base rubber. In addition, the amount of the peptizing agent is preferably 0.1 part by mass or more and 5 parts by mass or less with respect to 100 parts by mass of (a) the base rubber.

Examples of the embodiment of the rubber composition include an embodiment containing, as (d) the benzothiazole compound, at least one member selected from the group consisting of the compound represented by the formula (1), the compound represented by the formula (2) and the compound represented by the formula (3) (embodiment 1); and an embodiment containing, as (d) the benzothiazole compound, at least one member selected from the group consisting of the compound represented by the formula (1), the compound represented by the formula (2) and the compound represented by the formula (3), and (f) the organic sulfur compound (second embodiment).

The molar ratio ((d)/(c)) of the mole of (d) the benzothiazole compound to the mole of (c) the crosslinking initiator in the rubber composition is preferably 0.5 or more, more preferably 1.0 or more, and even more preferably 1.5 or more, and is preferably 10 or less, more preferably 7 or less, and even more preferably 5 or less. If the molar ratio ((d)/(c)) is 0.5 or more, the obtained crosslinked rubber has further enhanced hardness, and if the molar ratio ((d)/(c)) is 10 or less, the obtained crosslinked rubber has better properties.

In the rubber composition of the second embodiment, the mass ratio ((d)/(f)) of (d) the benzothiazole compound to (f) the organic sulfur compound is preferably 0.5 or more, more preferably 1 or more, and even more preferably 1.5 or more, and is preferably 10 or less, more preferably 8 or less, and even more preferably 5 or less. If the mass ratio ((d)/(f)) is 0.5 or more, the crosslinking reaction can be effectively conducted, and if the mass ratio ((d)/(f)) is 10 or less, the obtained crosslinked rubber has better properties.

The rubber composition preferably contains (e) the metal compound, more preferably contains the zinc compound, and most preferably contains zinc oxide.

When the rubber composition contains the compound represented by the formula (1) and/or the compound represented by the formula (2), and (e) the metal compound, a ratio (M2/(M1 × valent)) of a total mole M2 of the compound represented by the formula (1) and the compound represented by the formula (2) to a product obtained by multiplying a mole M1 of (e) the metal compound by a valent of the metal included in (e) the metal compound is preferably 0.01 or more, more preferably 0.02 or more, and even more preferably 0.04 or more, and is preferably 1.0 or less, more preferably 0.5 or less, and even more preferably 0.1 or less.

When the rubber composition contains the compound represented by the formula (3) and (e) the metal compound, a ratio (M21/{(M1 × valent)+(M22 × valent)) of a mole M21 of the structure deriving from the compound represented by the formula (1) in the compound represented by the formula (3) to a sum of a product obtained by multiplying a mole M1 of (e) the metal compound by a valent of the metal included in (e) the metal compound and a product obtained by multiplying a mole M22 of the metal component in the compound represented by the formula (3) by a valent of the metal component in the compound represented by the formula (3) is preferably 0.01 or more, more preferably 0.02 or more, and even more preferably 0.04 or more, and is preferably 1.0 or less, more preferably 0.5 or less, and even more preferably 0.1 or less.

### Preparation of Rubber Composition

The rubber composition used in the present disclosure is obtained by mixing and kneading (a) the base rubber, (b) the co-crosslinking agent, (c) the crosslinking initiator, (d) the benzothiazole compound, and other additives to be added where necessary. The kneading method is not particularly limited. For example, the kneading is conducted by using a conventional kneading machine such as a kneading roll, a banbury mixer, and a kneader.

### Properties of Rubber Composition

The rubber composition according to the first embodiment is also characterized in that a ratio {(T2-T1)/(X-18)} falls within a predetermined numerical range, wherein X is an amount (parts by mass) of (b) the co-crosslinking agent with respect to 100 parts by mass of (a) the base rubber, T1 is a torque (N·m) at 35 seconds and T2 is a torque (N·m) at 45 seconds from a start of measuring the torque of the rubber composition when conducting a crosslinking test of the rubber composition at a temperature of 170° C. If the ratio {(T2-T1)/(X-18)} falls within the predetermined numerical range, the crosslinking is effectively formed.

When the rubber composition of the embodiment 1 contains the compound represented by the formula (1) and/or the compound represented by the formula (2), the ratio {(T2-T1)/(X-18)} of the rubber composition is 0.46 or more, preferably more than 0.55, more preferably more than 0.60, and even more preferably more than 0.65, and is preferably 3 or less, more preferably 2 or less, and even more preferably 1 or less.

When the rubber composition of the embodiment 1 contains the compound represented by the formula (1) and/or the compound represented by the formula (2), the difference (T2-T1) is preferably 6 or more, more preferably 7 or more, and even more preferably 8 or more, and is preferably 20 or less, more preferably 17 or less, and even more preferably 15 or less.

When the rubber composition of the embodiment 1 contains the compound represented by the formula (3), the ratio {(T2-T1)/(X-18)} of the rubber composition is preferably 0.46 or more, more preferably more than 0.46, even more preferably more than 0.5, and most preferably more than 0.6, and is preferably 2 or less, more preferably 1.5 or less, and even more preferably 1 or less.

When the rubber composition of the embodiment 1 contains the compound represented by the formula (3), the difference (T2-T1) is preferably 0.3 or more, more preferably 0.4 or more, even more preferably 0.5 or more, and most preferably 3 or more, and is preferably 20 or less, more preferably 17 or less, even more preferably 15 or less, and most preferably 10 or less.

The rubber composition according to the second embodiment (the case containing (f) the organic sulfur compound) is also characterized in that a ratio {(T4-T3)/(X-18)} falls within a predetermined numerical range, wherein X is an amount (parts by mass) of (b) the co-crosslinking agent with respect to 100 parts by mass of (a) the base rubber, T3 is a torque (N·m) at 10 seconds and T4 is a torque (N·m) at 60 seconds from a start of measuring the torque of the rubber composition when conducting a crosslinking test of the rubber composition at a temperature of 170° C. If the ratio {(T4-T3)/(X-18)} falls within the predetermined numerical range, the crosslinking is effectively formed.

The ratio {(T4-T3)/(X-18)} of the rubber composition according to the second embodiment is preferably more than 0.3, more preferably 0.35 or more, and even more preferably 0.4 or more, and is preferably 2 or less, more preferably 1.5 or less, and even more preferably 1 or less.

The difference (T4-T3) of the rubber composition according to the second embodiment is preferably 1.5 or more, more preferably 2 or more, and even more preferably 3 or more, and is preferably 8 or less, more preferably 7 or less, and even more preferably 6 or less.

### Crosslinked Rubber Molded Product

The crosslinked rubber molded product according to the present disclosure is formed from the above-described rubber composition. The crosslinked rubber molded product is obtained by molding the kneaded rubber composition in a mold. The molding temperature is preferably 120° C. or more, more preferably 150° C. or more, and is preferably 250° C. or less. In addition, the molding pressure preferably ranges 2.9 MPa to 11.8 MPa. The molding time preferably ranges from 10 minutes to 60 minutes.

Examples of the crosslinked rubber molded product include a sports goods such as a golf ball, a tennis ball and a grip; an industrial goods such as a hose, a belt, and a mat; a sole, a tire, a resin additive, a shockproof rubber, and a fender. Examples of the golf ball include a golf ball comprising a constituent member formed from the above-described rubber composition.

### EXAMPLES

Next, the present disclosure will be described in detail by way of examples. However, the present disclosure is not limited to the examples described below. Various changes and modifications without departing from the spirit of the present disclosure are included in the scope of the present disclosure.

### Evaluation Method

### Slab Hardness (Shore C)

Sheets with a thickness of about 2 mm were produced by heat pressing at a temperature of 170° C. for 20 minutes. The test piece was stored at a temperature of 23 ± 2° C. and a relative humidity of 50 ± 5% for at least 12 hours. At least three of these sheets were stacked on one another so as not to be affected by the measuring substrate on which the sheets were placed, and the hardness of the stack was measured with an automatic hardness tester (Digitest II, available from Bareiss company) using a detector of “Shore C”.

### Lupke Rebound Resilience (%)

The rebound resilience test was conducted according to JIS K6255 (2013). Sheets having a thickness of about 2 mm were prepared by heat press molding at a temperature of 170° C. for 20 minutes, round-shaped pieces having a diameter of 28 mm were punched from the sheets, and six of the round-shaped pieces were stacked to prepare a cylindrical test piece having a thickness of about 12 mm and a diameter of 28 mm. The test piece was stored at a temperature of 23 ± 2° C. and a relative humidity of 50 ± 5 % for at least 12 hours. The rebound resilience of the obtained test piece was measured using a Lupke rebound resilience test measurement apparatus available from Ueshima Seisakusho Co., Ltd. The plane part of the above stacked test piece was held by a mechanical fixing method, and the measurement was conducted under conditions of a temperature: 23° C., a relative humidity: 50%, an impact end diameter: 12.50 ± 0.05 mm, an impact mass: 0.35 ± 0.01 kg, and an impact speed: 1.4 ± 0.01 m/s.

### Crosslinking Test

An appropriate amount of samples was sampled from the rubber compositions, and vulcanization curves of the samples were measured with a curemeter (CURELASTOMETER Type 7 available from JSR Trading Co. Ltd.) at a temperature of 170° C. According to “9. Die vulcanization testing method A” of “Measurement of vulcanization characteristics with oscillating curemeters” specified in JIS K6300-2 (2001), a sinusoidal oscillation with a low amplitude was applied from a lower die to the rubber test piece in a manner that the sinusoidal oscillation did not destroy the rubber test piece, and a torque transmitted from the test piece to an upper die was measured from un-vulcanization state to over-vulcanization state. The measurement was conducted under conditions of a torsional vibration number: 100 times per minute, and an amplitude angle: 1°.

### Preparation of Rubber Composition

According to the formulations shown in Table 1, the rubber compositions were kneaded with a kneading roll, to prepare rubber compositions. The obtained rubber compositions were evaluated.

Table 1

| | | | | | | | | |
|---|---|---|---|---|---|---|---|---|
| Rubber composition No. | | 1 | 2 | 3 | 4 | 5 | 6 | 7 |
| Formulation (parts by mass) | BR | 100 | 100 | 100 | 100 | 100 | 100 | 100 |
| | ZN-DA90S | 28 | 28 | 28 | 28 | 28 | 28 | 28 |
| | ZnO | 5.0 | 5.0 | 5.0 | 5.0 | 5.0 | 5.0 | 5.0 |
| | PBDS | | 0.5 | | | | | |
| | NOCCELER EUR | | | 1.0 | | | | |
| | NOCCELER M-P | | | | 1.0 | | | |
| | NOCCELER CZ-G | | | | | 1.0 | | |
| | SANCELER TBZTB | | | | | | 1.0 | |
| | NOCCELER EZ | | | | | | | 1.0 |
| | DCP | 0.8 | 0.8 | 0.8 | 0.8 | 0.8 | 0.8 | 0.8 |
| Crosslinking test | Torque T1 (N·m) at 35 seconds | 1.80 | 1.13 | 2.09 | 2.04 | 1.19 | 0.30 | 1.33 |
| | Torque T2 (N·m) at 45 seconds | 5.82 | 1.60 | 4.87 | 9.17 | 1.86 | 0.37 | 2.90 |
| | Difference (T2-T1) | 4.02 | 0.46 | 2.78 | 7.13 | 0.67 | 0.07 | 1.57 |
| | Ratio {(T2-T1)/(X-18)} | 0.40 | 0.05 | 0.28 | 0.71 | 0.07 | 0.01 | 0.16 |
| | Torque T3 (N-m) at 10 seconds | 0.21 | 0.21 | 0.20 | 0.22 | 0.22 | 0.22 | 0.22 |
| | Torque T4 (N·m) at 60 seconds | 11.10 | 2.62 | 6.84 | 12.74 | 4.29 | 0.48 | 5.77 |
| | Difference (T4-T3) | 10.89 | 2.41 | 6.64 | 12.52 | 4.07 | 0.27 | 5.55 |
| | Ratio {(T4-T3)/(X-18)} | 1.09 | 0.24 | 0.66 | 1.25 | 0.41 | 0.03 | 0.56 |
| Slab properties | Slab hardness (Shore C hardness) | 81.6 | 78.9 | 76.2 | 83.2 | 75.0 | 70.9 | 79.6 |
| | Rebound resilience (%) | 64.3 | 71.4 | 70.2 | 64.6 | 69.3 | 71.8 | 64.8 |

Table 2

| | | | | | | | | | | | |
|---|---|---|---|---|---|---|---|---|---|---|---|
| Rubber composition No. | | 8 | 9 | 10 | 11 | 12 | 13 | 14 | 15 | 16 | 17 |
| Formulation (parts by mass) | BR | 100 | 100 | 100 | 100 | 100 | 100 | 100 | 100 | 100 | 100 |
| | ZN-DA90S | 24 | 25 | 26 | 32 | 24 | 26 | 32 | 26 | 30 | 30 |
| | ZnO | 5.0 | 5.0 | 5.0 | 5.0 | 5.0 | 5.0 | 5.0 | 5.0 | 5.0 | 5.0 |
| | PBDS | | | | | 0.5 | 0.5 | 0.5 | 0.5 | 0.5 | |
| | PCTP-Zn | | | | | | | | | | 0.5 |
| | NOCCELER M-P | | | | | | | | 1.0 | 1.0 | 1.0 |
| | Thiazole disulfide | | | | | | | | | | |
| | Thiazole Zn | | | | | | | | | | |
| | DCP | 0.8 | 0.8 | 0.8 | 0.8 | 0.8 | 0.8 | 0.8 | 0.8 | 0.8 | 0.8 |
| Crosslinking test | Torque T1 (N·m) at 35 seconds | 1.61 | 1.66 | 1.70 | 2.02 | 1.04 | 1.08 | 1.19 | 1.22 | 1.24 | 1.09 |
| | Torque T2 (N m) at 45 seconds | 3.97 | 4.43 | 4.89 | 8.37 | 1.43 | 1.51 | 1.73 | 1.80 | 1.87 | 1.68 |
| | Difference (T2-T1) | 2.36 | 2.78 | 3.19 | 6.35 | 0.40 | 0.43 | 0.54 | 0.58 | 0.63 | 0.59 |
| | Ratio {(T2-T1)/(X-18)} | 0.39 | 0.40 | 0.40 | 0.45 | 0.07 | 0.05 | 0.04 | 0.07 | 0.05 | 0.05 |
| | Torque T3 (N·m) at 10 seconds | 0.21 | 0.21 | 0.21 | 0.21 | 0.21 | 0.21 | 0.21 | 0.22 | 0.22 | 0.21 |
| | Torque T4 (N·m) at 60 seconds | 7.79 | 8.64 | 9.49 | 14.77 | 2.16 | 2.39 | 3.11 | 4.19 | 4.64 | 5.11 |
| | Difference (T4-T3) | 7.57 | 8.43 | 9.28 | 14.56 | 1.94 | 2.18 | 2.90 | 3.97 | 4.43 | 4.89 |
| | Ratio {(T4-T3)/(X-18)} | 1.26 | 1.20 | 1.16 | 1.04 | 0.32 | 0.27 | 0.21 | 0.50 | 0.37 | 0.41 |
| Slab properties | Slab hardness (Shore C hardness) | 78.0 | 78.9 | 79.8 | 84.3 | 74.0 | 76.4 | 82.6 | 78.9 | 83.9 | 84.1 |
| | Rebound resilience (%) | 70.2 | 68.7 | 67.2 | 62.5 | 74.2 | 72.8 | 68.1 | 72.6 | 67.6 | 65.7 |

Table 3

| | | | | | | | | | | | |
|---|---|---|---|---|---|---|---|---|---|---|---|
| Rubber composition No. | | 18 | 19 | 20 | 21 | 22 | 23 | 24 | 25 | 26 | 27 |
| Formulation (parts by mass) | BR | 100 | 100 | 100 | 100 | 100 | 100 | 100 | 100 | 100 | 100 |
| | ZN-DA90S | 26 | 30 | 26 | 30 | 26 | 30 | 26 | 30 | 26 | 30 |
| | ZnO | 5.0 | 5.0 | 5.0 | 5.0 | 5.0 | 5.0 | 5.0 | 5.0 | 5.0 | 5.0 |
| | PBDS | | | | | | | | | | |
| | PCTP-Zn | | | | | | | | | | |
| | NOCCELER M-P | 1.0 | 1.0 | 5.0 | 5.0 | | | | | | |
| | Thiazole disulfide | | | | | 0.99 | 0.99 | | | | |
| | Thiazole Zn | | | | | | | 1.19 | 1.19 | 5.9 | 5.9 |
| | DCP | 0.8 | 0.8 | 0.8 | 0.8 | 0.8 | 0.8 | 0.8 | 0.8 | 0.8 | 0.8 |
| Crosslinking test | Torque T1 (N·m) at 35 seconds | 1.83 | 1.98 | 7.02 | 8.98 | 0.32 | 0.34 | 1.65 | 1.94 | 7.02 | 8.98 |
| | Torque T2 (N·m) at 45 seconds | 6.62 | 9.07 | 10.24 | 13.40 | 0.44 | 0.47 | 5.33 | 10.05 | 10.24 | 13.40 |
| | Difference (T2-T1) | 4.79 | 7.09 | 3.22 | 4.42 | 0.12 | 0.13 | 3.67 | 8.11 | 3.22 | 4.42 |
| | Ratio {(T2-T1)/(X-18)} | 0.60 | 0.59 | 0.40 | 0.37 | 0.01 | 0.01 | 0.46 | 0.68 | 0.40 | 0.37 |
| | Torque T3 (N·m) at 10 seconds | 0.21 | 0.21 | 0.21 | 0.21 | 0.21 | 0.21 | 0.22 | 0.21 | 0.21 | 0.21 |
| | Torque T4 (N·m) at 60 seconds | 10.68 | 14.30 | 11.40 | 14.81 | 0.64 | 0.70 | 10.43 | 14.51 | 11.40 | 14.81 |
| | Difference (T4-T3) | 10.47 | 14.08 | 11.19 | 14.59 | 0.43 | 0.49 | 10.22 | 14.30 | 11.19 | 14.59 |
| | Ratio {(T4-T3)/(X-18)} | 1.31 | 1.17 | 1.40 | 1.22 | 0.05 | 0.04 | 1.28 | 1.19 | 1.40 | 1.22 |
| Slab properties | Slab hardness (Shore C hardness) | 80.9 | 83.9 | 78.6 | 82.9 | 75.0 | 80.2 | 81.1 | 84.8 | 78.60 | 82.90 |
| | Rebound resilience (%) | 65.7 | 62.2 | 65.8 | 62.6 | 69.7 | 66.1 | 64.5 | 60.7 | 65.8 | 62.6 |

Table 4

| | | | | | | | | | | | |
|---|---|---|---|---|---|---|---|---|---|---|---|
| Rubber composition No. | | 28 | 29 | 30 | 31 | 32 | 33 | 34 | 35 | 36 | 37 |
| Formulation (parts by mass) | BR | 100 | 100 | 100 | 100 | 100 | 100 | 100 | 100 | 100 | 100 |
| | ZN-DA90S | 23 | 26 | 28 | 29 | 24 | 28 | 26 | 28 | 29 | 32 |
| | ZnO | 5.0 | 5.0 | 5.0 | 5.0 | 5.0 | 5.0 | 5.0 | 5.0 | 5.0 | 5.0 |
| | PCTP-Zn | 0.5 | 0.5 | 0.5 | 0.5 | 0.5 | 0.5 | 0.5 | 0.5 | 0.5 | 0.5 |
| | NOCCELER M-P | 1.0 | 1.0 | 1.0 | 1.0 | | | | | | |
| | Thiazole Na | | | | | 1.0 | 1.0 | | | | |
| | DCP | 0.8 | 0.8 | 0.8 | 0.8 | 0.8 | 0.8 | 0.8 | 0.8 | 0.8 | 0.8 |
| Crosslinking test | Torque T1 (N·m) at 35 seconds | 1.02 | 1.07 | 1.11 | 1.13 | 1.05 | 1.11 | 0.99 | 1.05 | 1.08 | 1.13 |
| | Torque T2 (N m) at 45 seconds | 1.51 | 1.64 | 1.72 | 1.76 | 1.61 | 1.75 | 1.46 | 1.62 | 1.61 | 1.73 |
| | Difference (T2-T1) | 0.49 | 0.57 | 0.61 | 0.63 | 0.56 | 0.64 | 0.47 | 0.57 | 0.53 | 0.60 |
| | Ratio {(T2-T1)/(X-18)} | 0.10 | 0.07 | 0.06 | 0.06 | 0.09 | 0.06 | 0.06 | 0.06 | 0.05 | 0.04 |
| | Torque T3 (N·m) at 10 seconds | 0.22 | 0.22 | 0.22 | 0.22 | 0.22 | 0.22 | 0.22 | 0.23 | 0.22 | 0.22 |
| | Torque T4 (N·m) at 60 seconds | 3.15 | 4.14 | 5.28 | 5.85 | 4.07 | 6.00 | 2.56 | 3.03 | 3.27 | 4.36 |
| | Difference (T4-T3) | 2.93 | 3.92 | 5.05 | 5.62 | 3.86 | 5.78 | 2.34 | 2.80 | 3.05 | 4.14 |
| | Ratio {(T4-T3)/(X-18)} | 0.59 | 0.49 | 0.51 | 0.51 | 0.64 | 0.58 | 0.29 | 0.28 | 0.28 | 0.30 |
| Slab properties | Slab hardness (Shore C hardness) | 75.7 | 79.3 | 81.3 | 82.3 | 75.2 | 80.0 | 77.6 | 79.9 | 81.0 | 83.1 |
| | Rebound resilience (%) | 72.1 | 67.5 | 65.6 | 64.6 | 74.1 | 68.8 | 70.2 | 67.9 | 66.7 | 64.9 |

Materials used in Tables 1 to 4 are shown as follows.

BR: “BR730” (high-cis polybutadiene rubber (cis-1,4 bond content = 96 mass %, 1,2-vinyl bond content = 1.3 mass %, Moony viscosity (ML₁₊₄ (100° C.) = 55, molecular weight distribution (Mw/Mn) = 3)) available from JSR Corporation

ZN-DA90S: zinc acrylate (including 10 mass % of zinc stearate) available from Nisshoku Techno Fine Chemical Co., Ltd.

ZnO: “Ginrei R” (zinc oxide) available from Toho Zinc Co., Ltd.

PBDS: bis(pentabromophenyl) disulfide available from Kawaguchi Chemical Industry Co. Ltd.

PCTP-Zn: zinc pentachlorothiophenol available from FUJIFILM Wako Chemicals Corporation

NOCCELER (register trademark) EUR: N,N′-diethylthiourea available from Ouchi Shinko Chemical Industry Co., Ltd.

NOCCELER M-P: 2-mercaptobenzothiazole available from Ouchi Shinko Chemical Industry Co., Ltd.

NOCCELER CZ-G: N-cyclohexyl-2-benzothiazolylsulfenamide available from Ouchi Shinko Chemical Industry Co., Ltd.

NOCCELER TBZTB: tetrabenzylthiuram disulfide available from Ouchi Shinko Chemical Industry Co., Ltd.

NOCCELER EZ: zinc diethyldithiocarbamate available from Ouchi Shinko Chemical Industry Co., Ltd.

Thiazole disulfide: 2,2'-dithiobisbenzothiazole available from Tokyo Chemical Industry Co., Ltd.

Thiazole Zn: zinc 2-mercaptobenzothiazole available from FUJIFILM Wako Chemicals Corporation

Thiazole Na: sodium 2-mercaptobenzothiazole available from Tokyo Chemical Industry Co., Ltd.

DCP: “Percumyl (register trademark) D” (dicumyl peroxide) available from NOF Corporation

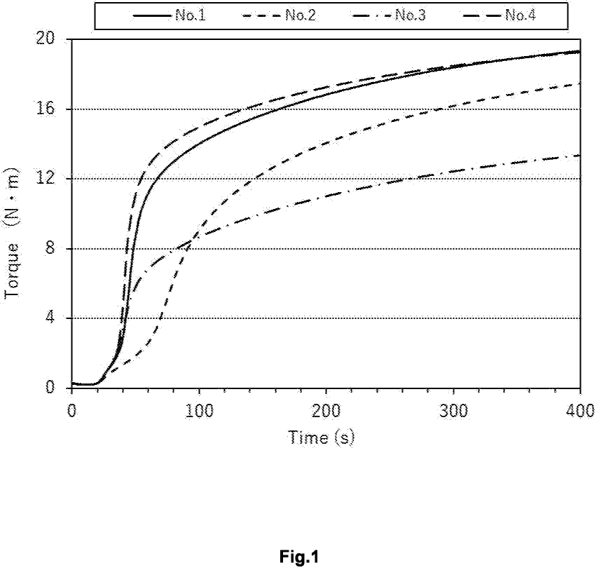

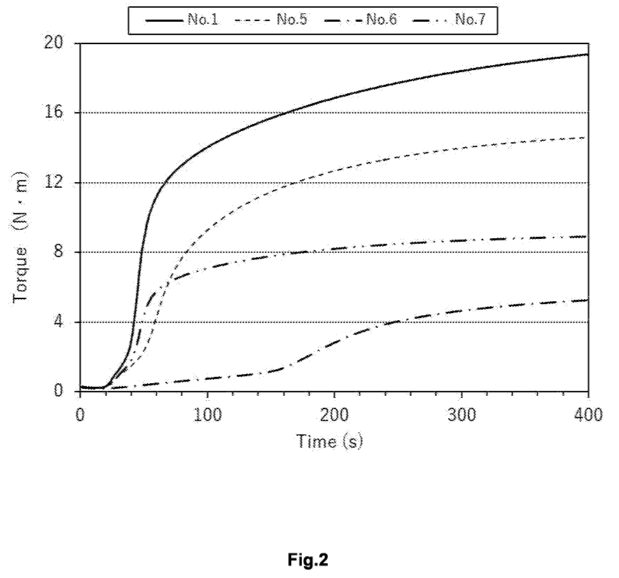

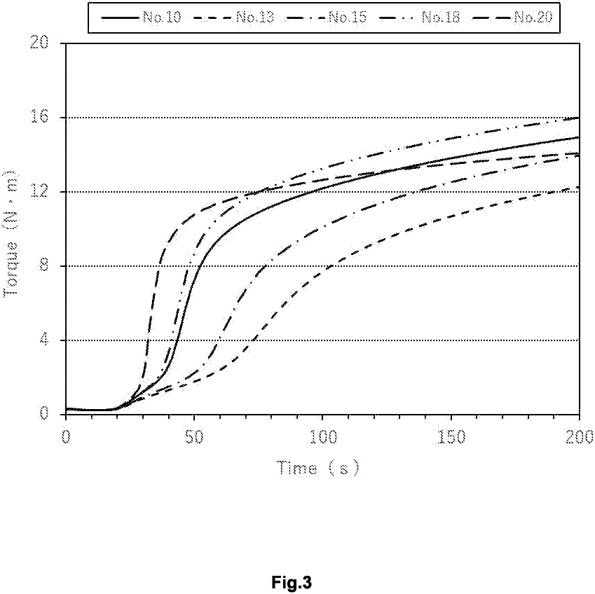

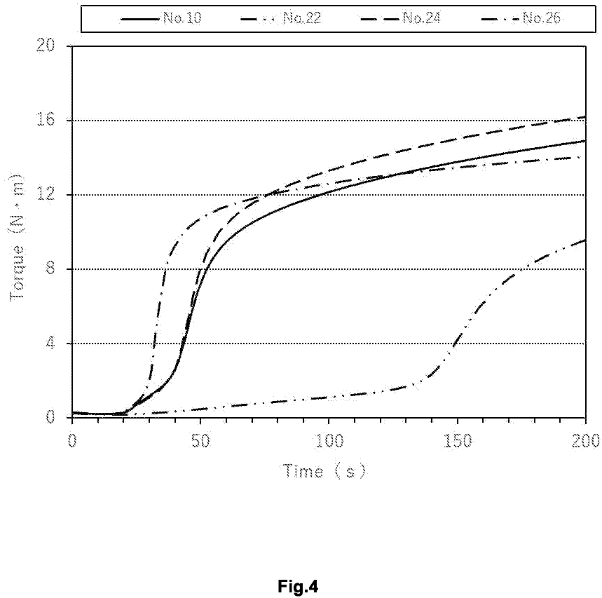

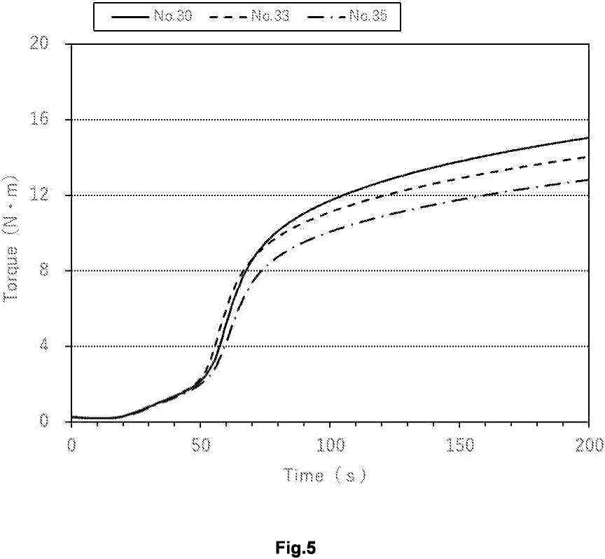

The slab hardness and the Lupke rebound resilience of the crosslinked rubber obtained from the rubber composition are shown in Tables 1 to 4. In addition, the relationship between the crosslinking time and the torque in the crosslinking test is shown in FIGS. 1 to 5.

The rubber compositions No. 4, 18 and 19 are the cases in which the compound represented by the formula (1) is contained as (d) the benzothiazole compound and {(T2-T1)/(X-18)} is 0.46 or more. The rubber compositions No. 24 and 25 are the cases in which the compound represented by the formula (3) is contained as (d) the benzothiazole compound and {(T2-T1)/(X-18)} is 0.46 or more. These rubber compositions No. 4, 18, 19, 24 and 25 formed a crosslinking in a shorter time than the rubber compositions No. 1 and 8 to 11. In addition, comparison of the rubber composition No. 4 with the rubber composition No. 1 indicated that the rubber composition No.4 increased the hardness of the obtained crosslinked rubber without increasing the amount of the co-crosslinking agent. In addition, comparison of the rubber composition No. 24 with the rubber composition No. 10 indicated that the rubber composition No.24 increased the hardness of the obtained crosslinked rubber without increasing the amount of the co-crosslinking agent.

It is noted that the rubber compositions No. 3 and 5 to 7 containing a compound other than (d) the benzothiazole compound required a longer time for crosslinking and lowered the hardness of the obtained crosslinked rubber.

In addition, the rubber compositions No. 2, 12 to 17, 22 and 23 containing bis(pentabromophenyl) disulfide, zinc pentachlorothiophenol or thiazole disulfide required a longer time for crosslinking, although the rebound resilience is enhanced.

The rubber compositions No. 28 to 31 are the cases in which the compound represented by the formula (1) is contained as (d) the benzothiazole compound, (f) the organic sulfur compound is further contained, and {(T4-T3)/(X-18)} is more than 0.30. The rubber compositions No. 32 and 33 are the cases in which the compound represented by the formula (3) is contained as (d) the benzothiazole compound, (f) the organic sulfur compound is further contained, and {(T4-T3)/(X-18)} is more than 0.30. The rubber compositions No. 34 to 37 are the cases in which (f) the organic sulfur compound is contained and (d) the benzothiazole compound is not contained.

The rubber compositions No. 28 to 33 formed a crosslinking in a shorter time than the rubber compositions No. 34 to 37. In addition, comparison of the rubber compositions No. 30 and 33 with the rubber composition No. 35 containing the same amount of the co-crosslinking agent indicated that the rubber compositions No. 30 and 33 have higher slab hardness than the rubber composition No. 35. Thus, using (d) the benzothiazole compound represented by the formula (1) and (f) the organic sulfur compound in combination enhances the rebound resilience while suppressing the lowering in the hardness.

The present disclosure (1) is a rubber composition containing (a) a base rubber, (b) a co-crosslinking agent, (c) a crosslinking initiator, and (d) a benzothiazole compound, wherein (d) the benzothiazole compound is at least one member selected from the group consisting of a compound represented by the formula (1), a compound represented by the formula (2), and a compound represented by the formula (3), and a relationship of {(T2-T1)/(X-18)} ≥ 0.46 is satisfied, wherein X is an amount (parts by mass) of (b) the co-crosslinking agent with respect to 100 parts by mass of (a) the base rubber, T1 is a torque (N·m) at 35 seconds and T2 is a torque (N·m) at 45 seconds from a start of measuring the torque of the rubber composition when conducting a crosslinking test of the rubber composition at a temperature of 170° C.

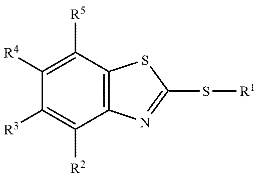

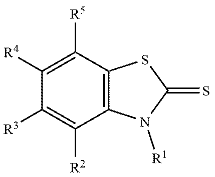

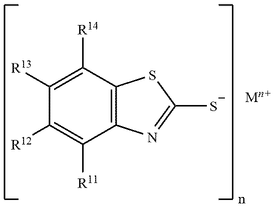

[R¹ represents a hydrogen atom, an alkyl group having 1 to 8 carbon atoms, an aryl group having 4 to 14 carbon atoms, or a metal atom, R² to R⁵ are identical to or different from each other and represent a hydrogen atom, a halogen atom, an alkyl group having 1 to 8 carbon atoms, an aryl group having 4 to 14 carbon atoms, an alkoxy group having 1 to 8 carbon atoms, or a perfluoroalkyl group having 1 to 8 carbon atoms, R¹¹ to R¹⁴ are identical to or different from each other and represent a hydrogen atom, a halogen atom, an alkyl group having 1 to 8 carbon atoms, an aryl group having 4 to 14 carbon atoms, an alkoxy group having 1 to 8 carbon atoms, or a perfluoroalkyl group having 1 to 8 carbon atoms, M represents a metal atom, and n represents 1 or 2.]

The present disclosure (2) is a rubber composition containing (a) a base rubber, (b) a co-crosslinking agent, (c) a crosslinking initiator, (d) a benzothiazole compound, and (f) an organic sulfur compound, wherein (d) the benzothiazole compound is at least one member selected from the group consisting of a compound represented by the formula (1), a compound represented by the formula (2), and a compound represented by the formula (3), and a relationship of {(T4-T3)/(X-18)} > 0.3 is satisfied, wherein X is an amount (parts by mass) of (b) the co-crosslinking agent with respect to 100 parts by mass of (a) the base rubber, T3 is a torque (N·m) at 10 seconds and T4 is a torque (N·m) at 60 seconds from a start of measuring the torque of the rubber composition when conducting a crosslinking test of the rubber composition at a temperature of 170° C.

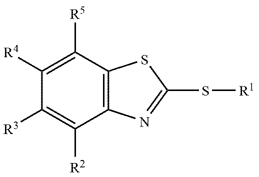

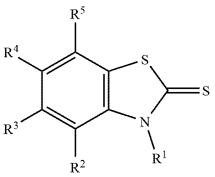

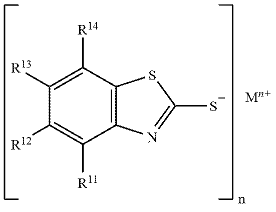

[R¹ represents a hydrogen atom, an alkyl group having 1 to 8 carbon atoms, an aryl group having 4 to 14 carbon atoms, or a metal atom, R² to R⁵ are identical to or different from each other and represent a hydrogen atom, a halogen atom, an alkyl group having 1 to 8 carbon atoms, an aryl group having 4 to 14 carbon atoms, an alkoxy group having 1 to 8 carbon atoms, or a perfluoroalkyl group having 1 to 8 carbon atoms, R¹¹ to R¹⁴ are identical to or different from each other and represent a hydrogen atom, a halogen atom, an alkyl group having 1 to 8 carbon atoms, an aryl group having 4 to 14 carbon atoms, an alkoxy group having 1 to 8 carbon atoms, or a perfluoroalkyl group having 1 to 8 carbon atoms, M represents a metal atom, and n represents 1 or 2.]

The present disclosure (3) is the rubber composition according to the present disclosure (1) or (2), wherein an amount of (d) the benzothiazole compound ranges from 0.01 part by mass to 20 parts by mass with respect to 100 parts by mass of (a) the base rubber.

The present disclosure (4) is the rubber composition according to any one of the present disclosures (1) to (3), wherein (b) the co-crosslinking agent includes an α,β-unsaturated carboxylic acid having 3 to 8 carbon atoms and/or a metal salt thereof.

The present disclosure (5) is the rubber composition according to any one of the present disclosures (1) to (4), wherein an amount of (b) the co-crosslinking agent ranges from 15 parts by mass to 50 parts by mass with respect to 100 parts by mass of (a) the base rubber.

The present disclosure (6) is a crosslinked rubber molded product formed from the rubber composition according to any one of the present disclosures (1) to (5).

The present disclosure (7) is a golf ball having a constituent member formed from the rubber composition according to any one of the present disclosures (1) to (5).

If the rubber composition according to the present disclosure is used, crosslinking is formed in a short time and the obtained crosslinked rubber molded product has a high hardness. Thus, the rubber composition according to the present disclosure is applied for a sports goods such as a golf ball, a tennis ball and a grip; an industrial goods such as a hose, a belt, and a mat; a sole, a tire, a resin additive, a shockproof rubber, a fender, and so on.

This application is based on Japanese Patent application No. 2021-137272 filed on Aug. 25, 2021 and Japanese Patent application No. 2021-180404 filed on Nov. 4, 2021, the contents of which are hereby incorporated by reference.

1. A rubber composition containing (a) a base rubber, (b) a co-crosslinking agent, (c) a crosslinking initiator, and (d) a benzothiazole compound, wherein
(d) the benzothiazole compound is at least one member selected from the group consisting of a compound represented by the formula (1), a compound represented by the formula (2), and a compound represented by the formula (3), and
a relationship of {(T2-T1)/(X-18)} ≥ 0.46 is satisfied, wherein X is an amount (parts by mass) of (b) the co-crosslinking agent with respect to 100 parts by mass of (a) the base rubber, T1 is a torque (N▪m) at 35 seconds and T2 is a torque (N▪m) at 45 seconds from a start of measuring the torque of the rubber composition when conducting a crosslinking test of the rubber composition at a temperature of 170° C., 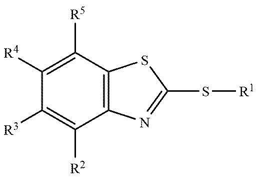 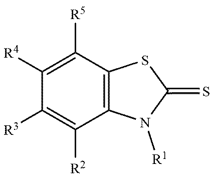 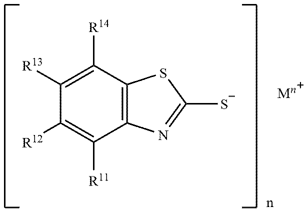
wherein R¹ represents a hydrogen atom, an alkyl group having 1 to 8 carbon atoms, an aryl group having 4 to 14 carbon atoms, or a metal atom, R² to R⁵ are identical to or different from each other and represent a hydrogen atom, a halogen atom, an alkyl group having 1 to 8 carbon atoms, an aryl group having 4 to 14 carbon atoms, an alkoxy group having 1 to 8 carbon atoms, or a perfluoroalkyl group having 1 to 8 carbon atoms, R¹¹ to R¹⁴ are identical to or different from each other and represent a hydrogen atom, a halogen atom, an alkyl group having 1 to 8 carbon atoms, an aryl group having 4 to 14 carbon atoms, an alkoxy group having 1 to 8 carbon atoms, or a perfluoroalkyl group having 1 to 8 carbon atoms, M represents a metal atom, and n represents 1 or 2.

2. A rubber composition containing (a) a base rubber, (b) a co-crosslinking agent, (c) a crosslinking initiator, (d) a benzothiazole compound, and (f) an organic sulfur compound, wherein
(d) the benzothiazole compound is at least one member selected from the group consisting of a compound represented by the formula (1), a compound represented by the formula (2), and a compound represented by the formula (3), and
a relationship of {(T4-T3)/(X-18)} > 0.3 is satisfied, wherein X is an amount (parts by mass) of (b) the co-crosslinking agent with respect to 100 parts by mass of (a) the base rubber, T3 is a torque (N▪m) at 10 seconds and T4 is a torque (N▪m) at 60 seconds from a start of measuring the torque of the rubber composition when conducting a crosslinking test of the rubber composition at a temperature of 170° C., 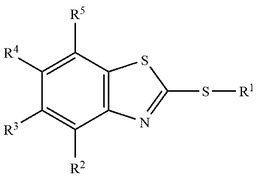 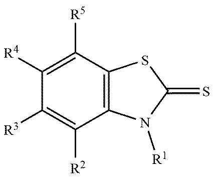 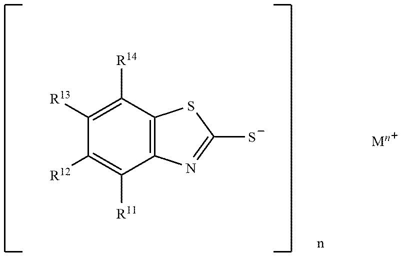
wherein R¹ represents a hydrogen atom, an alkyl group having 1 to 8 carbon atoms, an aryl group having 4 to 14 carbon atoms, or a metal atom, R² to R⁵ are identical to or different from each other and represent a hydrogen atom, a halogen atom, an alkyl group having 1 to 8 carbon atoms, an aryl group having 4 to 14 carbon atoms, an alkoxy group having 1 to 8 carbon atoms, or a perfluoroalkyl group having 1 to 8 carbon atoms, R¹¹ to R¹⁴ are identical to or different from each other and represent a hydrogen atom, a halogen atom, an alkyl group having 1 to 8 carbon atoms, an aryl group having 4 to 14 carbon atoms, an alkoxy group having 1 to 8 carbon atoms, or a perfluoroalkyl group having 1 to 8 carbon atoms, M represents a metal atom, and n represents 1 or 2.

3. The rubber composition according to claim 1, wherein an amount of (d) the benzothiazole compound ranges from 0.01 part by mass to 20 parts by mass with respect to 100 parts by mass of (a) the base rubber.

4. The rubber composition according to claim 2, wherein an amount of (d) the benzothiazole compound ranges from 0.01 part by mass to 20 parts by mass with respect to 100 parts by mass of (a) the base rubber.

5. The rubber composition according to claim 1, wherein (b) the co-crosslinking agent includes an α,β-unsaturated carboxylic acid having 3 to 8 carbon atoms and/or a metal salt thereof.

6. The rubber composition according to claim 2, wherein (b) the co-crosslinking agent includes an α,β-unsaturated carboxylic acid having 3 to 8 carbon atoms and/or a metal salt thereof.

7. The rubber composition according to claim 1, wherein an amount of (b) the co-crosslinking agent is more than 18 parts by mass and 50 parts by mass or less with respect to 100 parts by mass of (a) the base rubber.

8. The rubber composition according to claim 2, wherein an amount of (b) the co-crosslinking agent is more than 18 parts by mass and 50 parts by mass or less with respect to 100 parts by mass of (a) the base rubber.

9. A crosslinked rubber molded product formed from a rubber composition containing (a) a base rubber, (b) a co-crosslinking agent, (c) a crosslinking initiator, and (d) a benzothiazole compound, wherein
(d) the benzothiazole compound is at least one member selected from the group consisting of a compound represented by the formula (1), a compound represented by the formula (2), and a compound represented by the formula (3), and
a relationship of {(T2-T1)/(X-18)} ≥ 0.46 is satisfied, wherein X is an amount (parts by mass) of (b) the co-crosslinking agent with respect to 100 parts by mass of (a) the base rubber, T1 is a torque (N▪m) at 35 seconds and T2 is a torque (N▪m) at 45 seconds from a start of measuring the torque of the rubber composition when conducting a crosslinking test of the rubber composition at a temperature of 170° C., 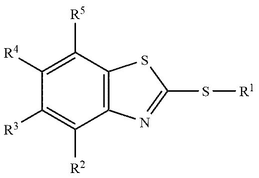 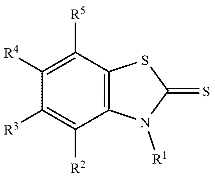 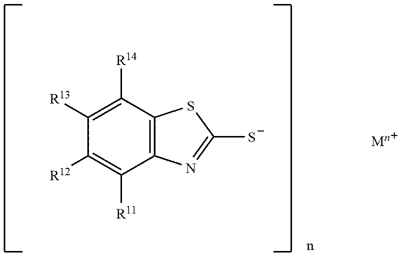
wherein R¹ represents a hydrogen atom, an alkyl group having 1 to 8 carbon atoms, an aryl group having 4 to 14 carbon atoms, or a metal atom, R² to R⁵ are identical to or different from each other and represent a hydrogen atom, a halogen atom, an alkyl group having 1 to 8 carbon atoms, an aryl group having 4 to 14 carbon atoms, an alkoxy group having 1 to 8 carbon atoms, or a perfluoroalkyl group having 1 to 8 carbon atoms, R¹¹ to R¹⁴ are identical to or different from each other and represent a hydrogen atom, a halogen atom, an alkyl group having 1 to 8 carbon atoms, an aryl group having 4 to 14 carbon atoms, an alkoxy group having 1 to 8 carbon atoms, or a perfluoroalkyl group having 1 to 8 carbon atoms, M represents a metal atom, and n represents 1 or 2.

10. The crosslinked rubber molded product according to claim 9, wherein an amount of (d) the benzothiazole compound ranges from 0.01 part by mass to 20 parts by mass with respect to 100 parts by mass of (a) the base rubber.

11. The crosslinked rubber molded product according to claim 9, wherein (b) the co-crosslinking agent includes an α,β-unsaturated carboxylic acid having 3 to 8 carbon atoms and/or a metal salt thereof.

12. The crosslinked rubber molded product according to claim 9, wherein an amount of (b) the co-crosslinking agent is more than 18 parts by mass and 50 parts by mass or less with respect to 100 parts by mass of (a) the base rubber.

13. A crosslinked rubber molded product formed from a rubber composition containing (a) a base rubber, (b) a co-crosslinking agent, (c) a crosslinking initiator, (d) a benzothiazole compound, and (f) an organic sulfur compound, wherein
(d) the benzothiazole compound is at least one member selected from the group consisting of a compound represented by the formula (1), a compound represented by the formula (2), and a compound represented by the formula (3), and
a relationship of {(T4-T3)/(X-18)} > 0.3 is satisfied, wherein X is an amount (parts by mass) of (b) the co-crosslinking agent with respect to 100 parts by mass of (a) the base rubber, T3 is a torque (N▪m) at 10 seconds and T4 is a torque (N▪m) at 60 seconds from a start of measuring the torque of the rubber composition when conducting a crosslinking test of the rubber composition at a temperature of 170° C., 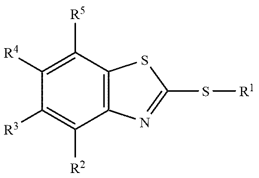 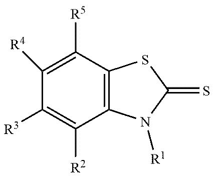 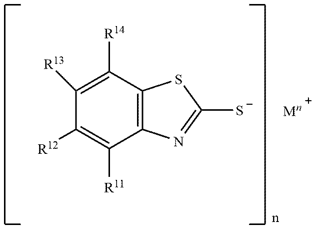
wherein R¹ represents a hydrogen atom, an alkyl group having 1 to 8 carbon atoms, an aryl group having 4 to 14 carbon atoms, or a metal atom, R² to R⁵ are identical to or different from each other and represent a hydrogen atom, a halogen atom, an alkyl group having 1 to 8 carbon atoms, an aryl group having 4 to 14 carbon atoms, an alkoxy group having 1 to 8 carbon atoms, or a perfluoroalkyl group having 1 to 8 carbon atoms, R¹¹ to R¹⁴ are identical to or different from each other and represent a hydrogen atom, a halogen atom, an alkyl group having 1 to 8 carbon atoms, an aryl group having 4 to 14 carbon atoms, an alkoxy group having 1 to 8 carbon atoms, or a perfluoroalkyl group having 1 to 8 carbon atoms, M represents a metal atom, and n represents 1 or 2.

14. The crosslinked rubber molded product according to claim 13, wherein an amount of (d) the benzothiazole compound ranges from 0.01 part by mass to 20 parts by mass with respect to 100 parts by mass of (a) the base rubber.

15. The crosslinked rubber molded product according to claim 13, wherein (b) the co-crosslinking agent includes an α,β-unsaturated carboxylic acid having 3 to 8 carbon atoms and/or a metal salt thereof.

16. The crosslinked rubber molded product according to claim 13, wherein an amount of (b) the co-crosslinking agent is more than 18 parts by mass and 50 parts by mass or less with respect to 100 parts by mass of (a) the base rubber.

17. A golf ball having a constituent member formed from a rubber composition containing (a) a base rubber, (b) a co-crosslinking agent, (c) a crosslinking initiator, and (d) a benzothiazole compound, wherein
(d) the benzothiazole compound is at least one member selected from the group consisting of a compound represented by the formula (1), a compound represented by the formula (2), and a compound represented by the formula (3), and
a relationship of {(T2-T1)/(X-18)} ≥ 0.46 is satisfied, wherein X is an amount (parts by mass) of (b) the co-crosslinking agent with respect to 100 parts by mass of (a) the base rubber, T1 is a torque (N▪m) at 35 seconds and T2 is a torque (N▪m) at 45 seconds from a start of measuring the torque of the rubber composition when conducting a crosslinking test of the rubber composition at a temperature of 170° C., 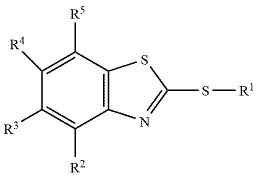 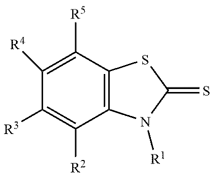 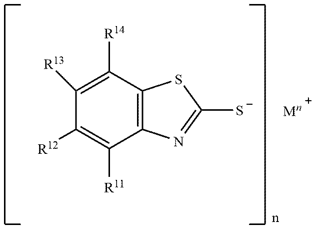
wherein R¹ represents a hydrogen atom, an alkyl group having 1 to 8 carbon atoms, an aryl group having 4 to 14 carbon atoms, or a metal atom, R² to R⁵ are identical to or different from each other and represent a hydrogen atom, a halogen atom, an alkyl group having 1 to 8 carbon atoms, an aryl group having 4 to 14 carbon atoms, an alkoxy group having 1 to 8 carbon atoms, or a perfluoroalkyl group having 1 to 8 carbon atoms, R¹¹ to R¹⁴ are identical to or different from each other and represent a hydrogen atom, a halogen atom, an alkyl group having 1 to 8 carbon atoms, an aryl group having 4 to 14 carbon atoms, an alkoxy group having 1 to 8 carbon atoms, or a perfluoroalkyl group having 1 to 8 carbon atoms, M represents a metal atom, and n represents 1 or 2.

18. The golf ball according to claim 17, wherein an amount of (d) the benzothiazole compound ranges from 0.01 part by mass to 20 parts by mass with respect to 100 parts by mass of (a) the base rubber.

19. The golf ball according to claim 17, wherein (b) the co-crosslinking agent includes an α,β-unsaturated carboxylic acid having 3 to 8 carbon atoms and/or a metal salt thereof.

20. The golf ball according to claim 17, wherein an amount of (b) the co-crosslinking agent is more than 18 parts by mass and 50 parts by mass or less with respect to 100 parts by mass of (a) the base rubber.

21. A golf ball having a constituent member formed from a rubber composition containing (a) a base rubber, (b) a co-crosslinking agent, (c) a crosslinking initiator, (d) a benzothiazole compound, and (f) an organic sulfur compound, wherein
(d) the benzothiazole compound is at least one member selected from the group consisting of a compound represented by the formula (1), a compound represented by the formula (2), and a compound represented by the formula (3), and
a relationship of {(T4-T3)/(X-18)} > 0.3 is satisfied, wherein X is an amount (parts by mass) of (b) the co-crosslinking agent with respect to 100 parts by mass of (a) the base rubber, T3 is a torque (N▪m) at 10 seconds and T4 is a torque (N▪m) at 60 seconds from a start of measuring the torque of the rubber composition when conducting a crosslinking test of the rubber composition at a temperature of 170° C., 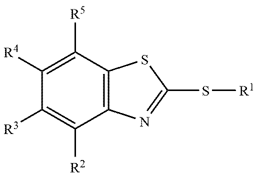 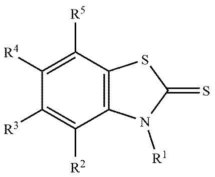 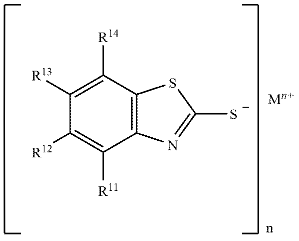
wherein R¹ represents a hydrogen atom, an alkyl group having 1 to 8 carbon atoms, an aryl group having 4 to 14 carbon atoms, or a metal atom, R² to R⁵ are identical to or different from each other and represent a hydrogen atom, a halogen atom, an alkyl group having 1 to 8 carbon atoms, an aryl group having 4 to 14 carbon atoms, an alkoxy group having 1 to 8 carbon atoms, or a perfluoroalkyl group having 1 to 8 carbon atoms, R¹¹ to R¹⁴ are identical to or different from each other and represent a hydrogen atom, a halogen atom, an alkyl group having 1 to 8 carbon atoms, an aryl group having 4 to 14 carbon atoms, an alkoxy group having 1 to 8 carbon atoms, or a perfluoroalkyl group having 1 to 8 carbon atoms, M represents a metal atom, and n represents 1 or 2.

22. The golf ball according to claim 21, wherein an amount of (d) the benzothiazole compound ranges from 0.01 part by mass to 20 parts by mass with respect to 100 parts by mass of (a) the base rubber.

23. The golf ball according to claim 21, wherein (b) the co-crosslinking agent includes an α,β-unsaturated carboxylic acid having 3 to 8 carbon atoms and/or a metal salt thereof.

24. The golf ball according to claim 21, wherein an amount of (b) the co-crosslinking agent is more than 18 parts by mass and 50 parts by mass or less with respect to 100 parts by mass of (a) the base rubber.
